(19) United States
(12) Patent Application Publication
(10) Pub. No.: US 2012/0037460 A1
(43) Pub. Date: Feb. 16, 2012

(54) DRIVE PULLEY FOR AN ELEVATOR INSTALLATION

(75) Inventor: Volker Zaph, Obernau (CH)

(73) Assignee: INVENTIO AG, Hergiswil (CH)

(21) Appl. No.: 13/145,438

(22) PCT Filed: Jan. 18, 2010
(86) PCT No.: PCT/EP2010/050544

§ 371 Date: Oct. 4, 2011

(30) Foreign Application Priority Data
Jan. 22, 2009 (EP) 09151077.6

(51) Int. Cl. B66B 15/04

(52) U.S. Cl. 187/255; 187/250

(57) ABSTRACT

A drive sheave for driving at least one traction device of an elevator system, including at least one traction area in which recesses are formed, which recesses extend substantially perpendicular to a circumferential direction of the drive sheave in the form of grooves, wherein the drive sheave is formed by a one-piece drive sheave body having the at least one traction area, and the grooves extend in the drive sheave body.

### FIELD

The invention relates to a drive pulley for driving a traction means of an elevator installation and to an elevator installation with such a drive pulley. Specifically, the invention relates to an elevator installation in which such a drive pulley drives a traction means which is constructed as a belt with an elastomeric casing, particularly as a wedge-ribbed belt.

### BACKGROUND

A traction cable pulley serving for co-operation with elevator cables is known from GB 1 121 220. In this traction cable pulley, inserts of plastics material are fixed at the periphery thereof and have traction surfaces for co-operation with the elevator cables or for the driving thereof. These traction surfaces form semicircular cable grooves for receiving round elevator cables, wherein the cable grooves are provided with transverse grooves oriented transversely to the longitudinal axis thereof. The purpose of these transverse grooves consists of guaranteeing the traction capability between drive pulley and elevator cable even when lubricating oil escapes from the elevator cable.

Such drive pulleys with plastics material inserts are, on the one hand complicated and expensive. However, the main problem is that such drive pulleys with diameters of less than 100 millimeters are not able to be realized in practice, since the fixing of the inserts with such small overall dimensions can no longer be executed with sufficient stability. However, such drive pulley diameters are currently commonplace in modern elevator drives.

### SUMMARY

An object of the invention is to create a drive pulley which enables an improved traction, can be produced with small diameter and is economic, as well as indicating an elevator with such a drive pulley. Specifically, it is an object of the invention to create a drive pulley and an elevator installation with a drive pulley in which creeping of the traction means at standstill as a consequence of a relatively pronounced difference between the traction forces effective in the two runs, which lead to the drive pulley, of the traction means is prevented or at least reduced. In particular, creeping in the co-operation of the drive pulley according to the invention with a traction means, the traction surface of which consists of an elastomer, shall be reduced or prevented.

It is to be noted that a traction means can have, apart from the function of supporting the elevator cage, also the function of transmitting the force or the torque of the drive motor to the elevator car in order to raise or lower the elevator car. In that case, the elevator car can be guided by one or more guide rails. The same applies to an optionally present counterweight.

The term “traction surface of a drive pulley” is to be understood as a circumferential surface of a drive pulley standing in contact with a traction means of the elevator installation and co-operating therewith for supporting and driving the traction means and an elevator car. Depending on the respective mode of construction of the traction means a single traction surface can be associated with an individual traction means or several traction surfaces of the drive pulley can be associated with an individual traction means. A drive pulley can co-operate with a single traction means or with several traction means. Round cables or flat belts, in particular, come into consideration as traction means.

According to one of the forms of embodiment of the invention the groove width of the grooves is less than 3 millimeters. It is ensured by this limitation of the groove width that the traction means, particularly an elastomeric casing of the traction means, does not penetrate too strongly into the grooves. Thus, on the one hand destruction of the traction means surface is prevented and, on the other hand, there is thus prevention of excessively load noises in the co-operation of traction means and drive pulley.

According to one of the forms of embodiment of the invention the drive pulley has several traction surfaces, which are arranged adjacent to one another, for several traction means arranged in parallel, wherein the grooves extend over all traction surfaces without interruption transversely to the circumferential direction of the drive pulley.

It is thereby achieved that the improvement in traction takes place over the entire groove width of the contact areas present between traction means and drive pulley and that lubricant and dirt can be conducted laterally away via the grooves.

According to one of the forms of embodiment of the invention a plurality of grooves is arranged with uniform distribution over the circumference of the drive pulley. Through the grooves present in large number, dirt, excess lubricant or the like can be conducted away and a reliable traction effect is ensured to a sufficient extent over the entire operating life.

According to one of the forms of embodiment of the invention the material of the drive pulley is hardenable steel, wherein at least one traction surface is hardened. A chromium steel or a chromium/nickel steel can also be used as material for production of a drive pulley according to the invention. The drive pulley can, however, also be produced from other metals or from a plastics material, for example from polyamide (PA) or polyetheretherketone (PEEK).

According to one of the forms of embodiment of the invention at least one traction surface has at least in part an increased surface roughness, wherein the traction surface has, for increasing the surface roughness, channels extending in a direction differing from the circumferential direction. Such traction surfaces additionally increase the traction capability between drive pulley and traction means, i.e. they additionally reduce the slip occurring between drive pulley and traction means. Surface roughnesses, particularly channels, can be formed in the traction surfaces by means of sandblasting or with the help of rotating steel-wire brushes.

According to one of the forms of embodiment of the invention at least one traction surface of the drive pulley is provided with an adhesion-enhancing coating. Such coatings can be applied in the form of, for example, hard-chromium coatings or in the form of thin hard-material layers with nanoparticles. Specifically, a so-termed topochromium coating can be provided. In that case a chromium layer is applied by electroplating, in which a structured layer covered by a thin final layer of chromium is formed from dome-shaped microstructures derived from a basic chromium layer. The construction of dome-shaped microstructures can be controlled by process parameters such as current strength, temperature and flow speed of the electrolyte during the electroplating coating process. Dome-shaped microstructures with diameters of, for example, less than 0.1 millimeters can thereby be formed.

An example of hard-material layers with nanoparticles is here the embedding of nanocrystals of AlTiN or AlCrN in a matrix of amorphous silicon nitride (Si₃N₄). However, a number of possibilities for producing hard-material layers on the basis of nanoparticles exists.

A preferred form of embodiment of the invention consists in that an elevator installation comprises, as traction means, at least one belt-like traction means with a casing of an elastomer which co-operates with a drive pulley having at least one of the afore-described features. An elevator installation with such a traction means has the advantage that the favorable properties of the traction means and the drive pulley according to the invention can be combined so as to avoid creeping between the drive pulley and the traction means at standstill. As elastomer use can be made of, in particular, a polyurethane, an ethylene-propylene rubber (EPDM) or a natural rubber.

### DESCRIPTION OF THE DRAWINGS

Preferred exemplifying embodiments of the invention are explained in more detail in the following description by way of the accompanying drawings, in which corresponding elements are provided with corresponding reference numerals and in which:

FIG. 1 shows a schematic illustration of an elevator installation in correspondence with a first exemplifying embodiment of the invention;

FIG. 2 shows a section through the elevator installation, which is shown in FIG. 1, along the section line denoted by II in correspondence with the first exemplifying embodiment of the invention; and

FIG. 3 shows the detail, which is denoted in FIG. 2 by III, of a drive pulley of an elevator installation in correspondence with a second exemplifying embodiment of the invention.

### DETAILED DESCRIPTION

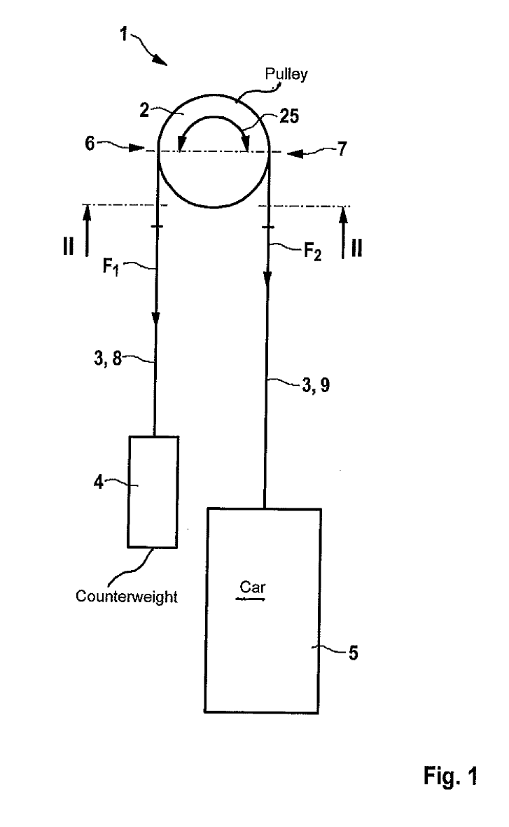

FIG. 1 shows an elevator installation 1 in a schematic illustration in correspondence with a first exemplifying embodiment of the invention. The elevator installation 1 comprises a drive pulley 2 serving for driving several traction means or traction devices 3-3E. In that regard, illustrated in FIG. 1 is a case in which on the one hand a counterweight 4 and on the other hand an elevator car 5 are suspended at the drive pulley 2 by way of the traction means 3-3E. In this regard, the traction force F1 acting at standstill of the drive pulley 2 and generated by the counterweight 4 and the traction force F2 generated by the elevator car 5 are illustrated, the forces acting at the sides 6 and 7 of the drive pulley 2 on the region of the traction means 3 looping over the drive pulley 2. The drive pulley 2 is connected with a drive motor unit and, for example, positioned in the upper region of a shaft of the elevator installation 1.

In FIG. 1 a case is illustrated in which the force F1 of the counterweight 4 is greater than the force F2 of the elevator car 5. For example, the elevator car 5 can be unloaded. The force of the counterweight 4 acts in the run (traction means section) 8 of the traction means 3 on the side 6 of the drive pulley 2. The force F2 of the elevator car 5 acts in the run 9 of the traction means 3 on the side 7 of the drive pulley 2. A ratio S of the forces F1 and F2 in the two runs 8 and 9, which lead away from the drive pulley 2, of the traction means 3 is determined as a quotient of a dividend equal to the force F1 of the counterweight 4 and a divisor equal to the force F2 of the lift cage elevator car 5:

S=F1/F2 (1)

If the ratio S is outside a range of approximately 1/Sₘₐₓ to approximately Sₘₐₓ, then there is the problem that when the drive pulley 2 is stationary a creeping occurs between the drive pulley 2 and the traction means 3. In this regard, Sₘₐₓ is necessarily greater than 1. In a conventional elevator this range can be determined by, for example, Sₘₐₓ=1.7. The larger the range determined by Sₘₐₓ, i.e. the larger Sₘₐₓ is, the more markedly different can the forces F1 and F2 also be without creeping occurring between the drive pulley 2 and the support means 3.

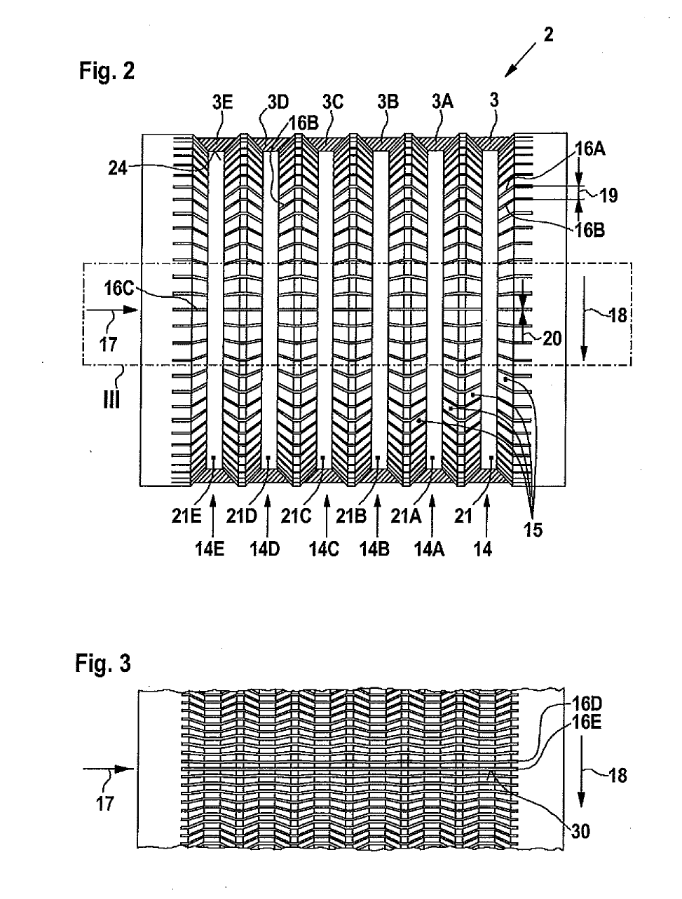

FIG. 2 shows a section through the elevator installation 1, which is shown in FIG. 1, along the section line designated by II. This section comprises sections through several traction means 3, 3A-3E as well as a view of the drive pulley 2 with several traction surfaces 15.

In the illustrated exemplifying embodiment the drive pulley 2 is provided with several V-grooves 14, 14A-14E which are oriented in the circumferential direction of the drive pulley 2 and in each of which a respective traction means 3, 3A-3E constructed as a V-belt is guided and loops around the drive pulley. In a preferred form of embodiment several such traction means can be connected together to form a so-termed wedge-ribbed belt.

Each of the V-grooves 14, 14A-14E of the drive pulley 2 has two flanks which each form a traction surface 15. The base surfaces 21, 21A-21E of the V-grooves 14, 14A-14E in this form of embodiment usually do not come into contact with the traction means 3, 3A-3E and therefore do not form traction surfaces.

The flanks of the V-grooves 14, 14A-14E forming the traction surfaces 15 have a plurality of recesses in the form of grooves 16A, 16B, 16C. The grooves 16A, 16B, 16C each extend in a direction 17 differing from a circumferential direction 18. Preferably, but not necessarily, the direction 17 is defined as a transverse direction 17 extending at right-angles to the circumferential direction 18. The direction 17 is in this case at least approximately at right-angles to the circumferential direction 18. The grooves 16A to 16C are arranged to be distributed uniformly over the traction surfaces 15, i.e. over the entire circumference of the drive pulley 2. In this regard, a uniform spacing 19 between the grooves 16A-16C, as is illustrated by way of the grooves 16A, 16B, is preferably selected. In order achieve a constant capability of traction and a minimum wear of the drive pulley and also the traction means it can be advantageous to produce the grooves with unequal spacings. In addition, the grooves 16A to 16C respectively have approximately the same groove width 20 as is illustrated by way of the groove 16C. The groove width 20 is advantageously selected to be less than 3 millimeters, preferably less than 2 millimeters and, with particular preference, less than 1 millimeter. Moreover, the grooves 16A to 16C are preferably formed to be sharp-edged, particularly with an edge radius of less than 0.01 millimeters.

Through the co-operation of the grooves 16A to 16C with the traction means 3, 3A-3E, particularly with an elastomeric casing of the traction means, an additional contribution to the traction effect between the traction surfaces 15 of the drive pulley 2 and the traction means 3, 3A-3E is achieved. The region defined by Sₘₐₓ in which the ratio S of the forces F1 and F2 can lie can thereby be increased without creep between the drive pulley 2 and the traction means occurring.

In the exemplifying embodiment illustrated in FIG. 2 the grooves 16A to 16C are formed by recesses or depressions which extend in the direction 17 and which are interrupted in the regions of the base surfaces 21, 21A-21E. The grooves 16A, 16B, 16C are thus present only in the region of the flanks of the V-grooves 14-14E, i.e. in the region of the traction surfaces 15. The traction surfaces 15 formed by the flanks can be provided entirely or partly with channels or the like in order to increase the surface roughness of these traction surfaces 15.

Preferred traction means are formed as encased steel cables or as belts, wherein the latter preferably comprise an elastomeric casing in which steel or synthetic fiber cable elements are embedded as tensile reinforcement. The casing preferably has a trapezium-shaped, round or rectangular cross-section or a cross-section with several V-shaped or trapezium-shaped ribs. However, use can also be made of so-termed wedge-ribbed belts which substantially form a composite of several V-belts.

The present invention is obviously also usable with drive pulleys with flat or curved traction surfaces which, for example, co-operate with one or more flat belts. In that case, several grooves arranged in distribution over the circumference of the drive pulley can each extend over the entire width or only over a part of the width of the at least one traction surface present between the at least one flat belt and the drive pulley.

The traction means 3, 3A to 3E are acted on by the forces F1, F2 illustrated in FIG. 1, so that the traction means in the region 25 (FIG. 1), in which they loop around the drive pulley 2, engage to some extent in the recesses or the grooves 16A to 16C. The traction means 3, 3A to 3E are thereby self-retaining to a certain extent at the recesses or the grooves 16A to 16C. The traction effect between the traction surfaces 15 of the drive pulley 2 and the traction means 3, 3A-3E is thereby amplified.

The recesses formed as grooves 16A, 16B, 16C can be produced, for example, by milling with a disc milling tool, by laser processing, by grinding with narrow grinding wheels, by roller embossing or in another manner.

FIG. 3 shows the detail, which is denoted in FIG. 2 by III, of the drive pulley 2 of an elevator installation 1 in correspondence with a second exemplifying embodiment of the invention. In this exemplifying embodiment a plurality of recesses in the form of grooves 16D, 16E is formed in the flanks, which form the traction surfaces 15, of the V-grooves 14-14E of the drive pulley 2, wherein in FIG. 3 for the sake of simplification only the grooves 16D, 16E are designated. In that case, all grooves 16D, 16E are formed to be of such depth that they also extend through the base surfaces 21, 21A-21E (FIG. 2) of the V-grooves 14, 14A-14E of the drive pulley 2. It is thus achieved that the grooves form continuous channels over substantially the entire width of the drive pulley 2. The conducting away of dirt, excess lubricant or the like is thereby facilitated. The grooves 16D, 16E in this exemplifying embodiment extend without interruption over all traction surfaces 15 in the transverse direction 17. These grooves 16D, 16E can also be produced, for example, by the afore-mentioned processing methods.

The traction surfaces 15 can be provided between the grooves 16D, 16E with an adhesion-enhancing coating 30. The coating can consist, for example, of hard chromium with dome-shaped microstructures or of thin hard-material layers with nanoparticles.

The drive pulley 2 can be formed as a separate disc. However, it can also be formed integrally with a shaft of a drive motor or a drive output shaft of a transmission motor,

The traction means 3 and the at least one traction surface of the drive pulley 2 are formed in such a manner that they can co-operate in advantageous manner. In the forms of embodiment illustrated in FIGS. 2 and 3 the traction means 3, 3A-3E have at the casing 24 thereof traction surfaces complementary with the traction surfaces 15 of the V-grooves 14, 14A-14E.

The invention is not restricted to the described exemplifying embodiments. In particular, it is usable in conjunction with any form of traction means in elevator construction.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A drive pulley for driving at least one traction device of an elevator installation comprising:
at least one traction surface formed on the drive pulley in which recesses formed as grooves extend substantially transversely to a circumferential direction of the drive pulley; and
wherein the drive pulley is formed as an integral drive pulley body having the at least one traction surface and the grooves, the grooves being formed by a roller embossing process.

15. The drive pulley according to claim 14 wherein the grooves have a width of less than 3 millimeters.

16. The drive pulley according to claim 14 wherein the drive pulley body has a plurality of mutually adjacent traction surfaces thereon for a plurality of parallel traction devices, wherein the grooves extend transversely to the circumferential direction of the drive pulley over all of the traction surfaces and the grooves are interrupted at a base surface of each of the traction surfaces.

17. The drive pulley according to claim 14 wherein the drive pulley body has a plurality of mutually adjacent traction surfaces thereon for a plurality of parallel traction devices, wherein the grooves extend without interruption transversely to the circumferential direction of the drive pulley over all of the traction surfaces.

18. The drive pulley according to claim 14 wherein the grooves are distributed substantially uniformly over a circumference of the drive pulley.

19. The drive pulley according to claim 14 wherein the drive pulley is formed of hardenable steel material and the at least one traction surface is hardened.

20. The drive pulley according to claim 19 wherein the at least one traction surface has at least a portion with an increased surface roughness, wherein the increased surface roughness is formed by channels which extend in a direction differing from the circumferential direction.

21. The drive pulley according to claim 14 wherein the at least one traction surface is provided at least partly with an adhesion-enhancing coating.

22. The drive pulley according to claim 21 wherein the coating has dome-shaped microstructures or thin hard-material layers with nanoparticles.

23. The drive pulley according to claim 14 wherein the at least one traction surface is formed with a V-shaped groove for co-operation with a V-belt, a wedge-ribbed belt or a flat belt.

24. An elevator installation with an elevator car suspended by at least one traction device, wherein the traction device has a casing of elastomer material and is guided over a drive pulley, the drive pulley comprising:
a drive pulley body having thereon at least one traction surface in which recesses, in a form of grooves, extend substantially transversely to a circumferential direction of the drive pulley for engaging the casing; and
wherein the drive pulley body is formed as an integral drive pulley body having the at least one traction surface and the grooves thereon and the grooves are formed by roller embossing the drive pulley body.

25. The elevator installation according to claim 24 wherein the traction device is formed as a traction belt.

26. The elevator installation according to claim 25 wherein the traction belt is formed as a V-belt, a wedge-ribbed belt or a flat belt.
